(19) United States
(12) Patent Application Publication
(10) Pub. No.: US 2014/0115624 A1
(43) Pub. Date: Apr. 24, 2014

(54) Security and Certification in a Set Top Box Device Having a Mixed Operating System or Framework Environment

(71) Applicant: BROADCOM CORPORATION, Irvine, CA (US)

(72) Inventor: Xuemin (Sherman) Chen, Rancho Santa Fe, CA (US)

(73) Assignee: BROADCOM CORPORATION, Irvine, CA (US)

(21) Appl. No.: 13/717,207

(22) Filed: Dec. 17, 2012

Related U.S. Application Data
(60) Provisional application No. 61/715,785, filed on Oct. 18, 2012.
(60) Provisional application No. 61/725,964, filed on Nov. 13, 2012.
(60) Provisional application No. 61/733,958, filed on Dec. 6, 2012.
(60) Provisional application No. 61/734,700, filed on Dec. 7, 2012.

(51) Int. Cl. H04N 21/25

(52) U.S. Cl. CPC H04N 21/25
USPC 725/25

(57) ABSTRACT

A set top box or similar device incorporating key management and certification support functions for establishing and maintaining compliance and flexibility with respect to applicable certification procedures and security measures when integrating untrusted components with an underlying secure operating system environment of the device. In various embodiments, the device incorporates untrusted software framework, such as an Android framework supported by a secure Linux operating system environment. The key management and certification support system operates to select hardware and software components of the device for use in establishing media pathways conforming to a desired level of security, and may be further operable to restrict access to a pathway in response to detection of an attempt to exploit the media pathway in an unauthorized manner. In one embodiment, a service operator or content provider may provide requisite certification or security requirements, or otherwise assist in selection of pathway components.

### CROSS-REFERENCE TO RELATED PATENTS/PATENT APPLICATIONS

### Provisional Priority Claims

The present U.S. Utility patent application claims priority pursuant to 35 U.S.C. §119(e) to the following U.S. Provisional patent applications which are hereby incorporated herein by reference in their entirety and made part of the present U.S. Utility patent application for all purposes:

1. U.S. Provisional Patent Application Ser. No. 61/715,785, entitled “INTEGRATION OF UNTRUSTED FRAMEWORK COMPONENTS WITH A SECURE OPERATING SYSTEM ENVIRONMENT,” (Attorney Docket No. BP30636), filed Oct. 18, 2012, pending.

2. U.S. Provisional Patent Application Ser. No. 61/725,964, entitled “INTEGRATION OF UNTRUSTED APPLICATIONS AND FRAMEWORKS WITH A SECURE OPERATING SYSTEM ENVIRONMENT,” (Attorney Docket No. BP30637), filed Nov. 13, 2012, pending.

3. U.S. Provisional Patent Application Ser. No. 61/733,958, entitled “SECURITY AND CERTIFICATION IN A SET TOP BOX DEVICE HAVING A MIXED OPERATING SYSTEM OR FRAMEWORK ENVIRONMENT,” (Attorney Docket No. BP30639), filed Dec. 6, 2012, pending.

4. U.S. Provisional Patent Application Ser. No. 61/734,700, entitled “SET TOP BOX ARCHITECTURE SUPPORTING MIXED SECURE AND UNSECURE MEDIA PATHWAYS,” (Attorney Docket No. BP30640), filed Dec. 7, 2012, pending.

### BACKGROUND OF THE INVENTION

1. Technical Field of the Invention

The present invention relates generally to media processing systems and, more particularly, to establishing and maintaining security and certification compliance when integrating untrusted components with a secure operating system environment in devices such as a set top box.

2. Description of Related Art

Attempts to accommodate relatively untrusted software applications or frameworks in certain types of devices may complicate applicable certification processes that are performed in accordance with one or more industry defined certification standards or testing procedures. For example, vendor certification of many set top boxes used by cable operators is conducted via rigid certification processes that test interoperability and security compliance for devices that implement specifications such as DOCSIS®, PacketCable™, CableHome™, and OpenCable™. Successful certification of such devices typically requires full end-to-end security. Likewise, digital rights management (DRM) and other technologies implemented in a particular device or component (such as a system-on-a-chip) may require distinct certification processes which do not allow certain interactions with an unsecured operating system (OS) environment or software framework. When implemented in a cable set top box, cable modem, media terminal adapter or like cable service device, certain specifications may require that a digital certificate be embedded in the device at the time of manufacture. Such certificates underpin a number of security features including device authentication and content integrity. By way of example, a digital certificate embedded in such devices helps prevent pirating of services by allowing a content provider or service operator to authenticate a device requesting services.

In general, any unsecured portions of a media pathway in a set top box or like device, if not isolated, will cause the certification of such pathway to fail. Most conventional set top boxes are designed to provide a single secure and certified pathway through the various elements or components of the device. In some recent multi-processor set top boxes, a conventional certified pathway is separated from untrusted components by creating a hardware boundary between the two. In particular, a first processing module is utilized to provide secure functionality (e.g., decoding operations), while a separate processing module with a lower security level is used to support an untrusted framework.

As is known, a software framework may provide application programming interface functionality and services that are not offered by an underlying operating system, and may thereby offer a level of platform independence in certain implementations. Frameworks are often designed to be a reusable and adaptable software system or subsystem. For example, Android has become one of the fastest-growing operating systems/frameworks for mobile devices. Android, which builds on contributions from the open-source Linux community, provides development tools and reusable components for building applications that can be deployed across many different types of devices, such as a smartphone or tablet device.

A typical Android framework is a “multi-user” Linux-based system in which each Android application is a different “user” having code that runs in general isolation from other applications. Such process isolation (or application “sandbox”) provides a certain level of security. However, various components, processes, threads, etc. used by an application may not entail sufficient protection when integrated in a set top box-type device, resulting in Android being considered an “untrusted” framework when used in such devices. For example, an application that visits an arbitrary web page or receives code from an unverified third party may result in untrusted JavaScript code being executed on a set top box, possibly with elevated privileges. Such code might exploit weakness in other code (e.g., browser code) and receive unauthorized access to file systems, etc., thereby compromising the security of a device, exposing protected data or introducing system instability.

As indicated above, the processing unit of some devices may have multiple processors or processing cores in order to provide higher performance and/or multi-tasking capabilities. In some of these multi-processor systems, when multiple applications or programs are running, access control is typically needed to separate the functionality of the applications running on multiple processors. Separation or segregation of different applications and/or tasks running on different processors helps to ensure that one application does not interfere with the execution of another. Likewise data assigned to one processor should not be accessed by another processor, unless that data is shared between the two processors. Such separation is typically handled through use of virtual memory, with each process having a unique view of memory that is not accessible from outside processes. Hardware access can be handled through a kernel or device driver interface, which provides some level of security. Even in a multi-processor system in which one processor environment provides trusted or secure operations while another operates in an unsecure or restricted environment, however, there can be a substantial possibility of an incursion from the unsecure zone into the secure zone when the operating system is managing the separation.

For example, in a set top box that allows a user to receive television signals and also allows the user to access the Internet, the secure environment may run applications (including a secure set top box application) pertaining to the reception, decryption and display of certain channels or content provided by a cable or satellite provider or other service operator. The unsecure environment in the set top box may execute applications, such as Android-based applications, that allow a user to access the Internet for web browsing, gaming, etc. In this example, the content provider would generally not want the user or anyone else to access the applications pertaining to broadcast or premium channels. However, if there is commonality in software that controls the accesses to both environments, such as running the same operating system to manage accesses in both environments, then there may be a heightened risk of access violations. Such violations, whether intentional or non-intentional, could result in an unsecure breach into the secure applications of the set top box, such as a web-originated intrusion into protected television channels.

Accordingly, there is a need to obtain an efficient way to integrate untrusted frameworks and applications with a secure operating system environment such as that of a set top box device, while also maintaining compliance and flexibility with respect to applicable certification procedures and security measures.

### BRIEF DESCRIPTION OF THE SEVERAL VIEWS OF THE DRAWINGS

FIG. 1 illustrates a media processing device having a key management and certification support system in accordance with an embodiment of the present disclosure.

FIG. 2 illustrates secure or certified pathways established in accordance with an embodiment of the present disclosure.

FIG. 3 illustrates exemplary certified pathway operational nodes in accordance with an embodiment of the present disclosure.

FIG. 4 is a logic diagram of a method for establishing a secure or certified pathway in a media processing device in accordance with an embodiment of the present disclosure.

FIG. 5 is a logic diagram of a method for dynamically establishing secure or certified media pathways in accordance with an embodiment of the present disclosure.

FIG. 6 illustrates an untrusted framework and a framework aggregator as clients of a secure operating system environment in accordance with various embodiments of the present disclosure.

FIG. 7 illustrates a set top box architecture utilizing certified applications in accordance with various embodiments of the present disclosure.

FIG. 8 illustrates an untrusted framework as a client of a set top box application in a virtualized environment in accordance with various embodiments of the present disclosure.

FIG. 9 illustrates partitioning of a framework into trusted and untrusted portions in accordance with an embodiment of the present disclosure.

FIG. 10 illustrates integration of trusted and untrusted software in a single processor environment in accordance with an embodiment of the present disclosure.

FIG. 11 illustrates integration of trusted and untrusted software in a multi-processor environment in accordance with an embodiment of the present disclosure.

FIG. 12 is a block diagram of a multi-processor system supporting hardware segregation of operating system environments in accordance with various embodiments of the present disclosure.

FIG. 13 is a schematic block diagram of a set top box (STB)/gateway (GW) in accordance with an embodiment of the present disclosure.

### DETAILED DESCRIPTION OF THE INVENTION

While certain embodiments are described in conjunction with an Android framework and/or Linux operating system, other embodiments of the present invention may be practiced with a variety of current or future operating systems/kernels and frameworks, and employ a variety of computing circuits, devices, servers and/or systems that might utilize multiple processors, processing cores and/or processing circuits.

Further, certain of the illustrations herein describe a processing module, a processor or a CPU (e.g. CPU1, CPU2) for a device that provides a processing function in the described embodiments. However, it is appreciated that a variety of other devices and/or nomenclature may be used in other embodiments to provide for the processing function in practicing the invention. The invention may be readily adapted to other usages where multiple processing environments (zones, domains, etc.) exist, in which separation and/or segregation between two or more zones is desired Likewise, while certain embodiments are described as implemented by a set top box (STB) or like media processing device performing trusted media processing operations, the novel architectures and methodologies are applicable in whole or in part to other devices, including media consumption devices such as PVR's, DVD players, access points, televisions, computing devices, smartphones, etc. As used herein, conditional access refers to the protection of content by requiring certain criteria to be met before granting access to this content, while DRM refers to any technology that inhibits uses of digital content that are not desired or intended by the content provider.

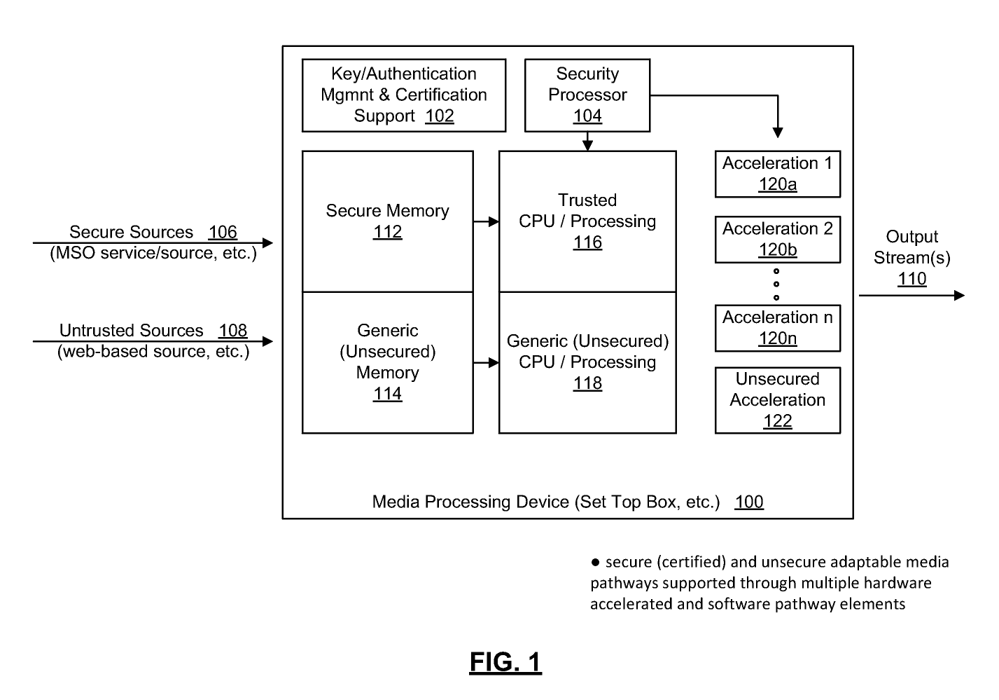

Referring now to FIG. 1, a media processing device 100 having a key management and certification support system 102 in accordance with an embodiment of the present disclosure is shown. The key management and certification support system 102, in conjunction with other device resources, operates to establish secure/certified and unsecure media pathways supported through multiple hardware accelerated and software pathway elements. Key management may entail associating different keys with different functions, enabling or controlling certain interfaces, controlling how keys are generated, stored and accessed, etc. The security processor 104 may service pathway configuration requests from the key management and certification support system 102, and may be further operable to detect attempts from the restricted operating system environment to exploit the media pathway or nodes thereof in an unauthorized manner, restrict access to a certified pathway, etc.

In operation, processing of content and application software from trusted sources 106 (such as service operator) may be restricted to trusted or certified pathway components such as secure memory 112, trusted/secure processing circuitry 116, and one or more secure hardware/software acceleration functions 120a-n in order to generate an output stream(s) 110. Likewise, processing of content and application software from untrusted sources 108 (such as certain web-based sources) may be restricted to untrusted components such as generic or unsecured memory 114, generic or unsecured processing circuitry 118, and unsecured hardware/software acceleration functions 122. Depending on requisite security levels, the effective boundaries between trusted and untrusted components may fluctuate in a dynamic manner.

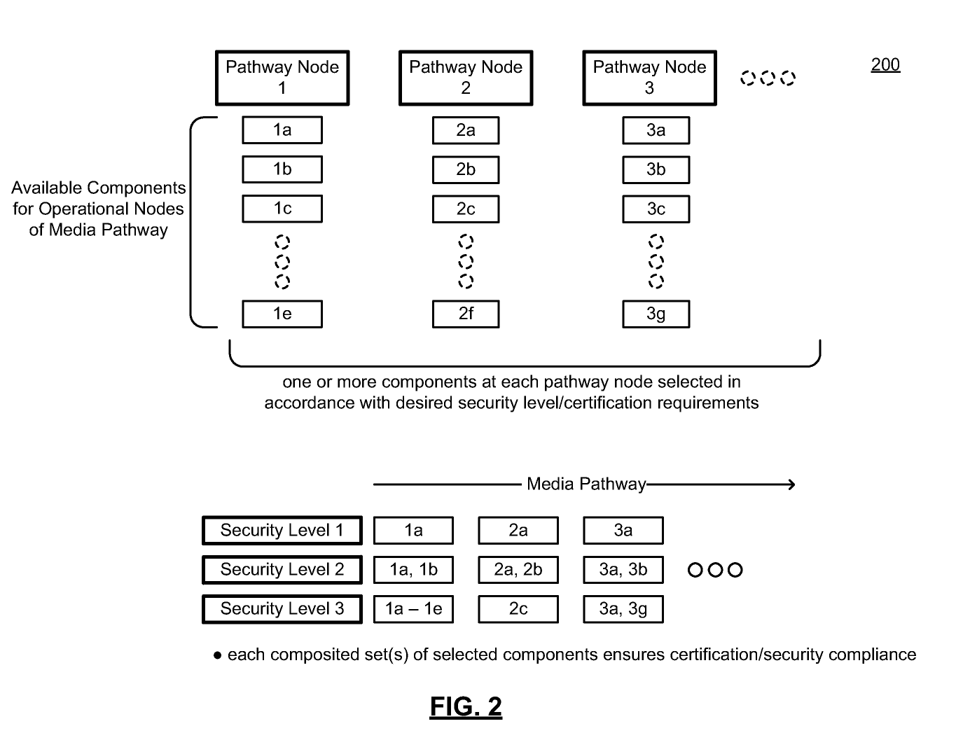

FIG. 2 illustrates secure or certified pathways established in accordance with an embodiment of the present disclosure. In this embodiment, hardware/software components at each operational pathway node are selected in accordance with a desired level of security 1-3. In general, each security level corresponds to a particular certification service boundary definition(s) and key/authentication and security management scheme for managing resources such as hardware acceleration functions and software API's. For example, a security level may relate to a copy-protection certification scheme that requires a certain guaranteed amount of secure memory and processing resources.

Selection and management of the respective components within the device or system to effectuate delivery of signals or media may be made based upon the secure or unsecure nature of a component, current or anticipated availability of components, historical availability of components, the performance level and power consumption of components, etc. Different sets of components may be adaptively employed to ensure composited compliance with one or more security/compliance constraints.

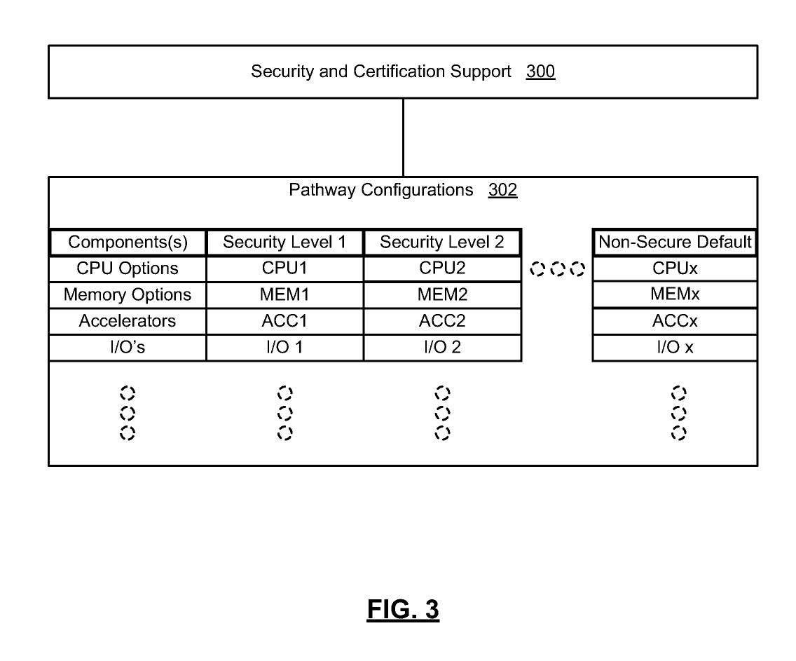

FIG. 3 illustrates exemplary certified pathway configurations 302 in accordance with an embodiment of the present disclosure. Selection of components that form the pathway configurations corresponding to a given security level is governed by security and certification support 300. Available components of a device may include, by way of example and without limitation, CPU/processing options, memory options, input/output interfaces, software APIs, hardware acceleration functions for performing video encoding, video decoding, rendering of 2D and 3D graphics, digital rights management, encryption, decryption, etc. Some components may perform or enable multimedia functionality such as audio/video capture, format conversion, playback, saving and streaming.

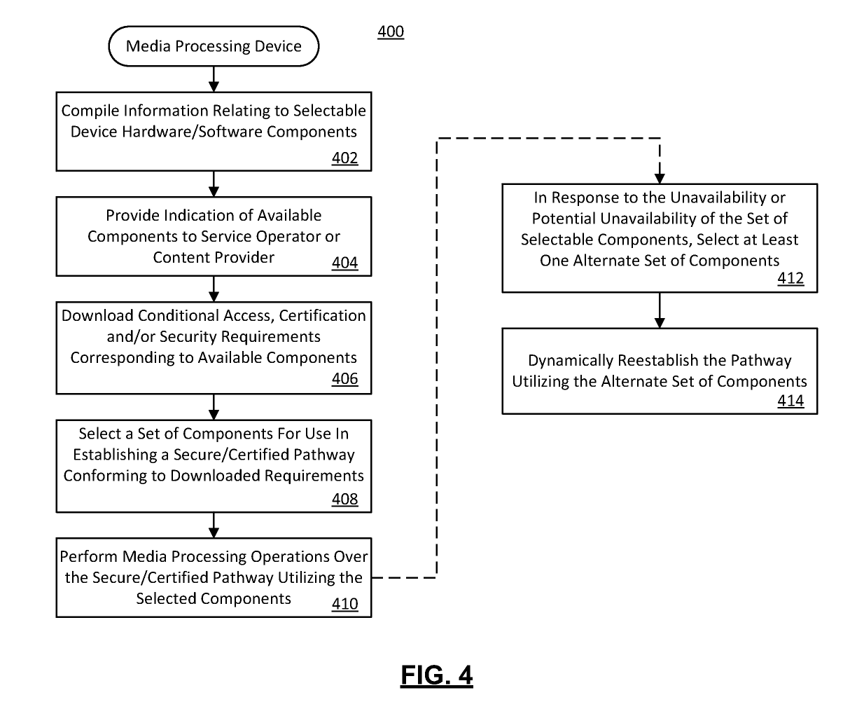

FIG. 4 is a logic diagram of a method 400 for establishing a secure or certified pathway in a media processing device such as a set top box having a plurality of selectable components in accordance with an embodiment of the present disclosure. In step 402, information is compiled relating to the selectable device hardware/software components (such as hardware accelerators, a/v decoders, DRM functions, decryption/encryption blocks, etc.). The information may be tabulated or otherwise compiled for use by the device and/or third party. Next, in step 404, an indication of available components is provided, for example, to a service operator or content provider. The recipient may respond by generating information for download (in step 406) including, by way of example, conditional access, certification and/or security requirements corresponding to available components. The downloaded information may correspond to one of a plurality of pre-established security levels. In various embodiments, for example, the desired level of security may correspond to requirements of an established or industry standard certification or testing procedure, requirements of a conditional access system utilized by a service operator, etc. Similarly, the desired level of security may correspond to a certification requirement for processing and delivery operations involving a particular content item or class of content items.

In step 408, a set of components is selected for use in establishing an appropriately secure or certified pathway that conforms to the downloaded requirements. In one example, the certified pathway is compliant with a certification or conditional access system utilized by a service operator affiliated with the media processing device. Media processing operations can then be performed over the secure or certified pathway (utilizing the selected set of components) in step 410.

In certain embodiments, such as shown in step 412, when one or more components of the selected set become unavailable or potentially unavailable, such as when usurped for use by a higher priority pathway or due to a change in security requirements, at least one alternate component or set of components is selected. In step 414, the alternate component(s) is utilized to dynamically reestablishing the pathway. In one example involving an attempted breach of security, the reestablished pathway results in restricted performance or performs other remedial measures.

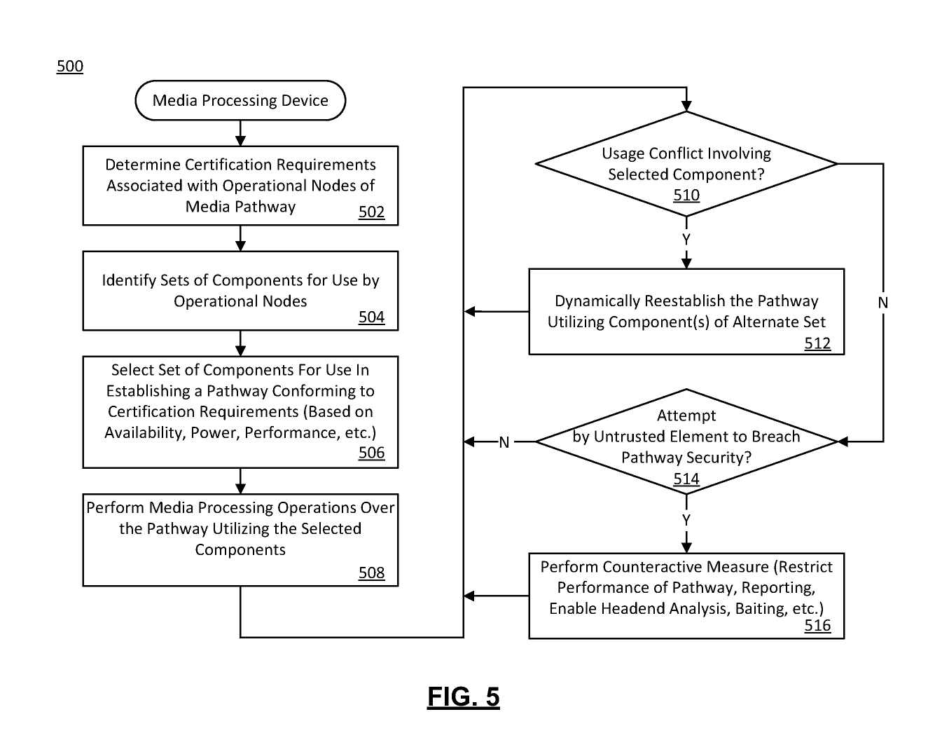

FIG. 5 is a logic diagram of a method 500 in accordance with an embodiment of the present disclosure for dynamically establishing secure or certified media pathways in a media processing device such as a set top box having a plurality of selectable components relating to operational nodes of the pathway. In step 502, certification requirements associated with the operational nodes of a prospective media pathway are determined. The certification requirements may be provided by an entity such as a service operator. Next, in step 504, a plurality of sets of components are identified for use by the operational nodes of the pathway. A set of components is then selected (step 506) for use in establishing a pathway conforming to the certification requirements and/or other security requirements. In one embodiment, the selection process is governed by a key management and certification support system of the media processing device. In addition to security, various factors may be utilized in the selection process, including comparative expected power consumption, comparative performance levels, combinations thereof, etc. In step 508, media processing operations can then be performed over the secure or certified pathway (utilizing the selected set of components).

If a usage conflict or potential usage conflict involving at least one component of the selected set of selectable components is subsequently identified in step 510, the method proceeds to step 512 where the pathway is dynamically reestablishing utilizing at least one component of another set of selectable components, such as a set selected in step 506. In addition, attempts to breach pathway security by untrusted elements may be monitored in step 514. When such an attempt or likely attempt is detected, remedial or counteractive measures are performed in step 516. Such measures may include novel functions such as restricting performance associated with the certified secure path, reporting, baiting, gathering and forwarding attacker information, capturing application download information, “limp along” modes of operation, enabling a pathway for a service operator head end to analyze an unsecure operating environment via a secure operating environment, etc.

The following Figures illustrate integration of untrusted software and software frameworks (such as an Android framework) with secure operating system (OS) kernel environments within a secure device (such as a certified set top box device) in accordance with various embodiments of the present disclosure. In general, an OS kernel may be viewed as the heart (or ring 0) of the operating system, providing an interface between system hardware components and the rest of the operating system and installed applications. As described more fully below, a secure software abstraction layer is provided to isolate access to underlying software, hardware and secure components of the device.

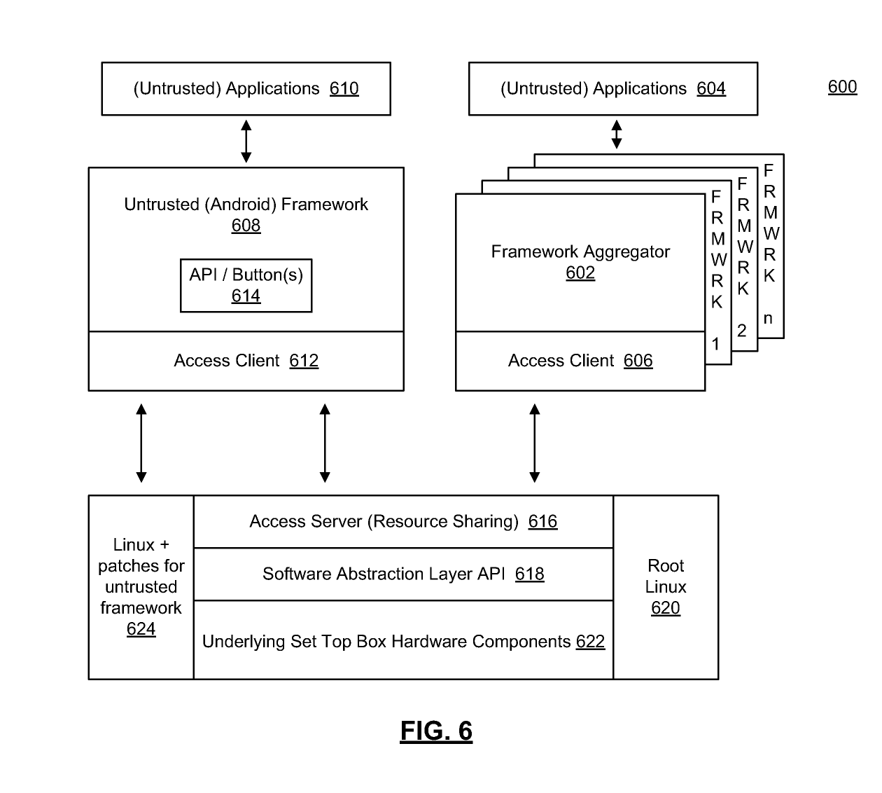

Communications and data exchanges between untrusted software/frameworks and a secure OS kernel may occur via a secure access layer or interface comprised of a secure access client and secure access server (for example, elements 606, 612 and 616 of FIG. 6) that support an application programming interface (API) and secure inter-process communication (IPC) calls or kernel drivers. In certain embodiments, the secure access client may be part of or accessible by a framework, while the associated secure access server is incorporated in a secure operating environment or executed as a secure kernel module. In operation, the secure access interface may help prevent system breaches or destabilization resulting from bad data or parameters by performing, without limitation, parameter validation/checking and peripheral range checking through hardware (when applicable), handle validation, direct/indirect heap pointer validation, heap isolation, and release of hardware resources following termination of a restricted process. The secure access server may limit access to server side libraries and return errors in response to invalid or illegal parameters passed by clients. The secure access interface may further perform watchdog functions to free resources reserved for runaway or unstable clients.

Software frameworks may support varying degrees of collaboration and dependencies between applications. However, the interfaces used by applications to provide services and communicate with other applications or an underlying operating system must be secured to defend against breaches and general malfeasance. As noted above in the Description of the Related Art, and without rigid hardware isolation and separate execution environments, the potential for execution of unauthorized code from an untrusted framework may compromise overall system security and negatively impact established certified or secured pathways absent methodologies and architectures (e.g., a secure access server) such as those described herein.

Referring now to FIG. 6, an untrusted framework 608 and a framework aggregator 602 as clients of a secure operating system environment in accordance with various embodiments of the present disclosure is shown. In the illustrated embodiment, the framework “aggregator” 602 may be employed to embrace and extend operation with a wide variety of frameworks 1-n in order to support a wide variety of (untrusted) applications 604. In this manner, for example, a service provider can provide secure access to system resources to third party frameworks and other “middleware” offerings. Such offerings may include, by way of example and without limitation, Adobe Air, Adobe Flash, Apple iOS, Microsoft Silverlight, Java applets, and like side-by-side technologies. The framework aggregator 602 may include a set of tailored operating system libraries and HTML capabilities to support such technologies, as well as user interface web engine access, etc.

In certain embodiments, user interfaces supported by the framework aggregator 602 may enable a user to launch applications supported by the untrusted framework 608. For example, an Android framework 608 and/or framework aggregator 602 may offer a series of APIs or buttons 614, including an Android button that provides a visual display of available Android applications. Further, the Android framework 608 and framework aggregator 602 may share a graphics screen. In this manner, it may not be necessary to port functionality into the Android framework 608 that might otherwise be necessary. It is noted that in a given device, an Android framework 608 may be built using a different tool chain than that utilized by other frameworks supported by the framework aggregator 602, and support execution of a different set of applications 610.

In the illustrated embodiment, the untrusted framework 608 and the framework aggregator 602 can access a secure or trusted root operating system—such as Linux-based operating system 620—and/or underlying hardware, such as secure set top box hardware components 622, via an access server 616 operating in concert with access clients 606 and 612 and a software abstraction layer API 618. In this illustrated embodiment, an access client 612 enables secure communications between the untrusted framework and access server 616, while the framework aggregator 602 is similarly supported by an access client 606.

A complete or partial Linux operating system instance 624, including any necessary software patches, is provided to support execution of the untrusted framework 608, and the access client 612 may further function to govern communications between the untrusted framework 608 and the complete or partial Linux operating system instance 624. Linux kernel components of an Android software stack may include, for example, a display driver, a USB driver, a keypad driver, a WiFi driver, an audio driver, power management, a binder (IPC) driver, a Bluetooth driver, a flash memory driver, etc. In addition, the framework 608 may include an API or one or more buttons 614 that enable, for example, a visual display of available applications 610 (which may be executed on the untrusted framework 608 using, for example, application IPC calls).

In one embodiment, execution of the untrusted framework 608 (including components thereof, as well as untrusted applications 610) is performed using process isolation techniques. Such process isolation techniques may entail, for example, utilizing virtual address space where the address space for a first process is different than that of a second process. Inter-process memory access may be prohibited, or tightly controlled in certain implementations (e.g., where system policies permit processes to collaborate over IPC channels such as shared memory or local sockets).

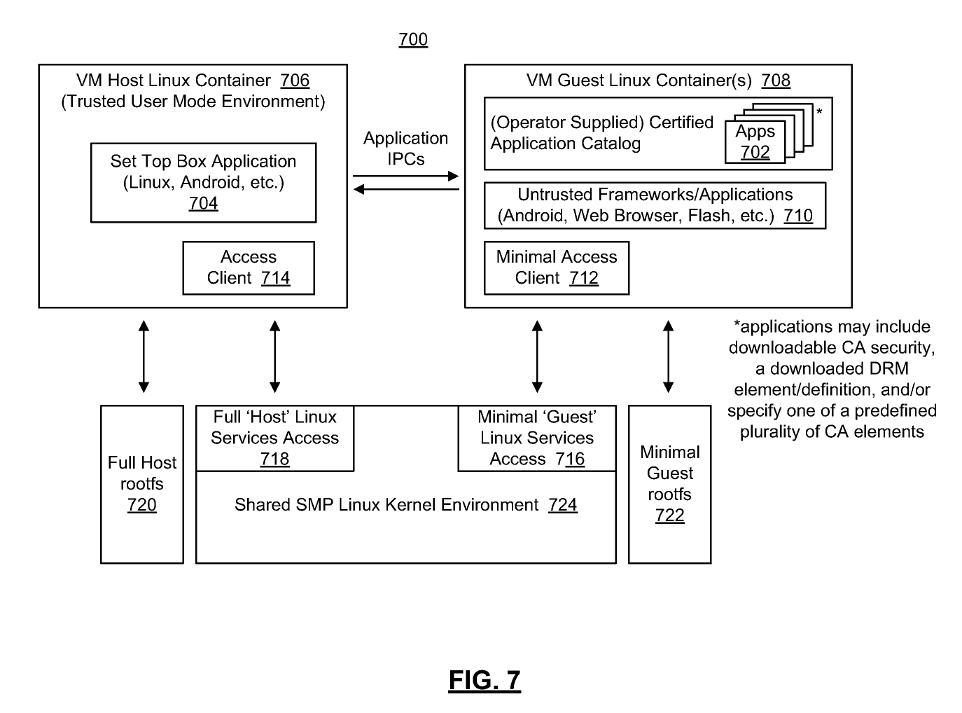

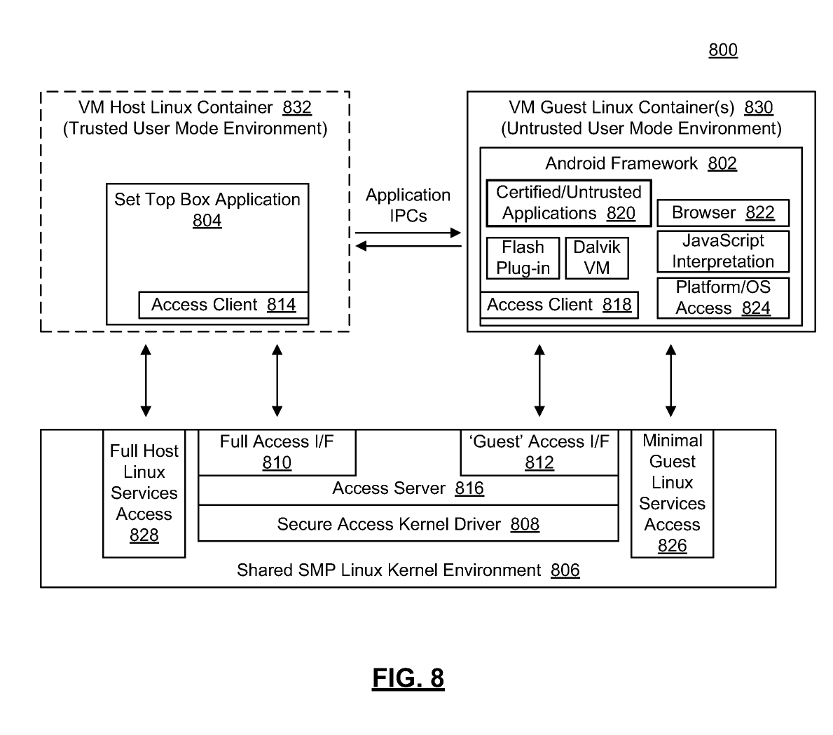

FIG. 7 illustrates a set top box or other secure architecture 700 utilizing certified applications 702 in accordance with the present disclosure. In the illustrated embodiments, the certified applications 702 may be preinstalled or downloaded, for example, from a catalog of certified applications provided by a service operator or cloud-based source. Such applications might include, by way of example, media streaming applications (e.g., Netflix), gaming applications, web browsing applications, iOS-based applications, Android applications, etc. In some embodiments, it may be necessary to incorporate or download additional operating systems to support corresponding classes of certified applications. Alternatively, different certified versions of a given application may be made available to support a variety of installed operating systems and/or frameworks 710. Certified applications 702 may be executed in one or more virtual machine containers 708 as described more fully below in conjunction with FIG. 8.

In the illustrated embodiment, untrusted client applications and frameworks interact with secure portions of an underlying set top box platform—including the set top box application 704, certified (operator supplied) applications 702 and secure Linux kernel environment 724 through application IPC calls and an access minimal client 712 that accesses minimal “guest” Linux services access 716. Likewise, applications in a trusted user mode (or “privileged”) operating system environment receive full access to “host” Linux services access 718 via an access client 714. The trusted user mode environment can be supported by a full host root filesystem 720, while a minimal guest root filesystem 722 on a separate partition or disk can support the untrusted user mode (or “restricted”) operating system environment.

In some embodiments, certain resources of a set top box platform, such as media processing and hardware acceleration resources (for audio/video encoding and decoding, rendering of 2D and 3D graphics using a standardized API (such as Open Graphics Library or “OpenGL”), DRM, encryption/decryption, etc.) and networking interfaces, may be accessed by untrusted client applications/frameworks 710 through IPC calls communicated through network sockets Likewise, events such as IR control signals may be communicated from a set top box platform to untrusted client applications/frameworks 710 through IPC calls (such as a call into an Android API or button).

In one exemplary embodiment, the primary set top box application 704 is constructed as an Android application executed in a virtual machine container(s) 706. Depending on the capabilities of the relevant Android framework, non-standard API's or libraries may be required to support certain set top box functionality, such as PVR, picture-in-picture, transcoding, and channel tuning operations. Further, this approach may require special interfacing (e.g., passing a string to an interface to create an encode path as part of a hardware call) or provision of non-standard functions (or even applications) to address services and functions that may be lacking in a relevant framework or required for certification. For example, an Android framework might be extended to include non-standard functionality—without negatively impacting compatibility—by providing services that are “hidden” under the Android porting layers and receive and interpret uniform resource identifiers (“URIs”) passed through such layers.

In other embodiments, instead of an end-to-end security definition being managed by the source or being defined by the content itself (or associated metadata), each application that is downloaded (or preinstalled) includes a full security definition. For example, each application may have its own downloadable conditional access security (dCAS) or downloadable DRM element/definition. A corresponding certification process might entail, for example, certifying a part of an overall secure pathway, with one or more applications providing the final portion of the certification. Alternatively, a predefined plurality of conditional access mechanisms may be provided, with a (downloaded) application defining which mechanism is to be used. It may then be possible to certify a secure “boundary” without regard to the conditional access requirements of a particular company or media.

In various embodiments, a set top box or like device may exchange capabilities with other devices in a media consumption network (e.g., PVR's, DVD players, access points, televisions, computing devices, smartphones, etc.) to compare against the requirements of an application. Once this is done, the application may select which one or more modes of operation, if any, that it will permit. If the set top box cannot support such modes (due to resource competition or otherwise), such modes become unavailable. If available a set of modes of operation can be selected and dynamically switched to other of such modes on the fly during a media stream delivery, which may require coordination with the application or the source to support the transition (possibly requiring quality changes in the media stream).

FIG. 8 illustrates an untrusted framework 802 as a client of a set top box application (“STB application”) 804 in a virtualized environment in accordance with various embodiments of the present disclosure. As shown, a STB application 804 is provided to perform basic operations of a set top box 800, and interfaces with an untrusted “client” framework such as an Android framework 802. In this embodiment, the STB application 804 is executed in a secure or privileged Linux operating system kernel environment, such as a Symmetric Multiprocessing (SMP) Linux kernel environment 806, that includes a secure access kernel driver 808 and an access server 816 that includes a full access interface 810 for use by the STB application 804, and a more limited guest access interface 812 for use by the Android framework 802 via an access client 818. The STB application 804 includes access client 814 functionality that supports communications with the full access interface 810 and enables the Android framework 802 to run as an untrusted client of the secure Linux kernel environment 806 using, for example, container-based virtualization. As may be appreciated, the client/server architecture allows untrusted processes to crash or terminate without compromising underlying hardware and causing system instability.

In addition to an access client 818, the Android framework 802 of the illustrated embodiment may include trusted/certified and/or untrusted applications and application support 820, JavaScript interpretation, browser functions 822, plug-ins (e.g., an Adobe Flash plug-in), and a Dalvik virtual machine. In some embodiments, certified applications 820 may be downloaded from or supplied by a service operator, content provider, cloud-based source or the like. The Android framework 802 further includes platform or operating system access functionality 824 that enables limited access to necessary components of the secure Linux kernel environment 806 through a minimal guest Linux services access interface 826.

A variety of virtualization techniques may be employed in various embodiments according to the present disclosure, including implementations utilizing virtual systems running on either a shared operating system kernel or separate operating system kernels. Selection of a particular approach may depend on the required level of isolation, as well as availability of processing and memory resources. In the illustrated embodiment, the untrusted Android framework 802 is executed in a first virtual machine (VM) guest Linux container(s) 830 (such as an “LXC” or Linux resource container) to provide further isolation from secure processes and resources. In this embodiment, the STB application may similarly operate in a second VM host Linux container 832 having full host Linux services access 828. Briefly, and in general, container-based virtualization (or operating system-level virtualization) allows a kernel to run with a plurality of isolated virtual machines or virtual environments installed on top of it. Each virtual environment may be dedicated to run a particular application, and is typically not a complete operating system instance, but rather a partial instance of the operating system that works with a virtualization layer (or hardware resource abstraction layer) in the host operating system kernel.

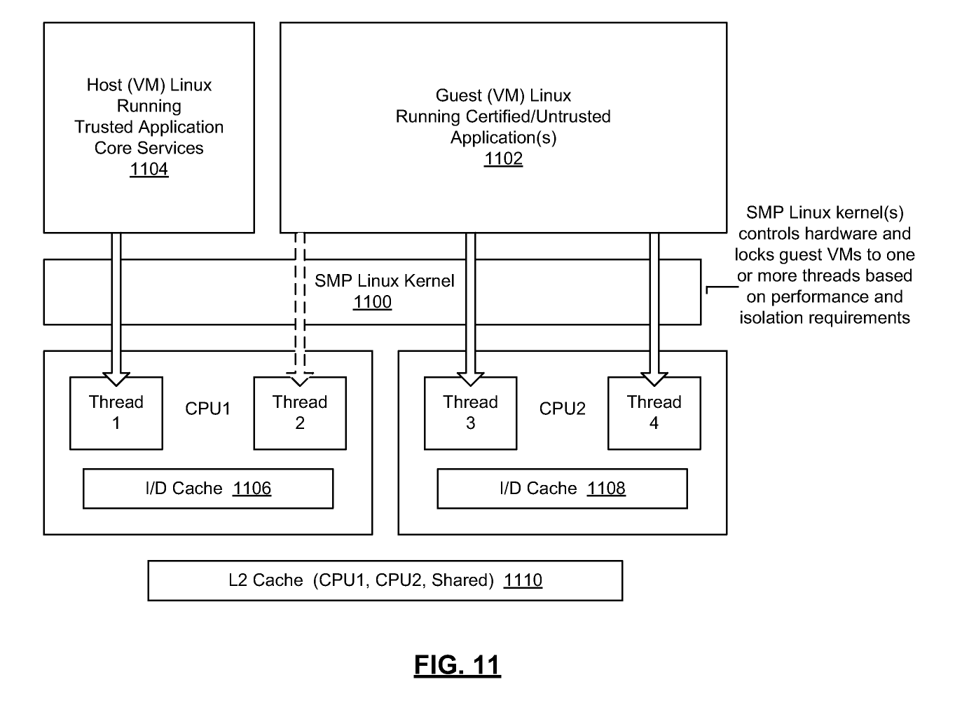

Although virtualization may mitigate the need for hardware separation of untrusted components, in certain embodiments multiple processors having different levels of security may benefit from virtual container constructs which operate wholly via one of such processors, while other containers may span multiple processors (see, for example, the embodiment illustrated in FIG. 11). In one such embodiment, a first processor(s) may be dedicated to execution of non-secure functionality, while a second, secure processor(s) may be dedicated to conventional STB functionality. In various alternate embodiments, an untrusted framework may be hardware sandboxed via, for example, non-processor hardware/peripherals, memory isolation from processors and/or peripherals, etc. Various other divisions between secure and untrusted software and hardware are contemplated (e.g., dividing an untrusted framework or applications themselves into a “trusted” portion and an “untrusted” portion), examples of which are described below. Further, by utilizing hardware and operating system virtualization features, multiple operating systems may run simultaneously on the same hardware.

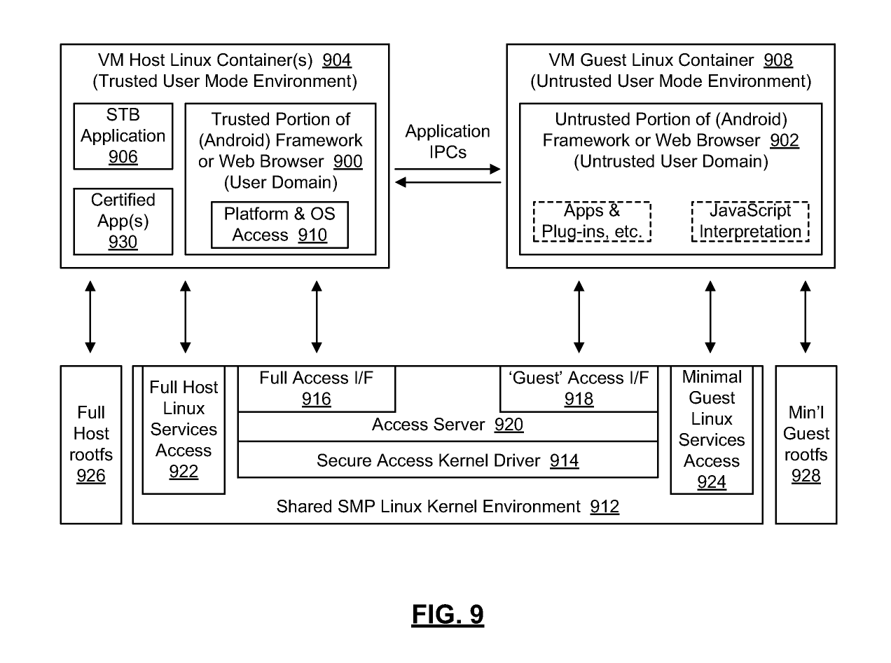

FIG. 9 illustrates partitioning of a framework into trusted and untrusted portions 900 and 902 in accordance with an alternate embodiment of the present disclosure. In this embodiment, a trusted portion(s) 900 of a (Android) framework 900, web browser, etc., and a corresponding untrusted portion(s) 902 are executed in one or more separate virtual machine containers 904 and 908, respectively. The trusted portion 900 may include a secure platform and operating system access interface 910. In addition to the trusted portion 900, a set top box application 906, as well as trusted or certified applications 930, may operate in virtual machine container(s) 904.

Using an example involving a web browser, the portion of the browser that executes potentially unsafe Flash or JavaScript code (such as a rendering engine) can be executed in the “untrusted” virtual machine container 908 with limited file system and peripheral access, while the portion of the browser that has access to underlying platform hardware and sensitive operating system resources can be executed in one or more “trusted” virtual machine containers 904. In further embodiments, the trusted portion 900 may comprise a secure clone of a framework, or modified version of a framework that supports secure applications and/or secure portions of applications. In such embodiments, unsecure applications or portions thereof may be executed by portions of a framework residing in an untrusted or restricted user domain or container. Various approaches to hardware sandboxing may be employed to further isolate untrusted portions of a framework and to support restricted operating system domains or environments.

The secure Linux kernel environment 912 of this embodiment includes a secure access kernel driver 914 and an access server 920 that provides a full access interface 916 to support trusted user mode functionality and a guest access interface 918 to support untrusted user mode functionality. Full host Linux services access 922 and minimal guest Linux services access 924 are provided to the trusted and untrusted user mode environments, respectively. As above, the trusted user mode environment can be supported by a full host root filesystem 926, while a minimal guest root filesystem 928 on a separate partition or disk supports the untrusted user mode environment.

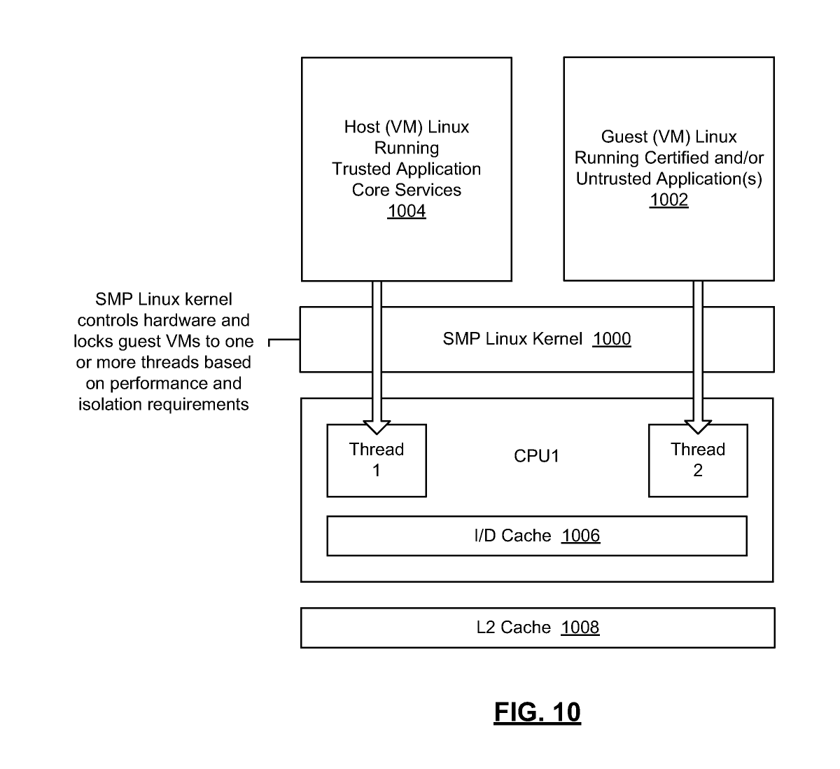

FIG. 10 illustrates integration of trusted and untrusted software in a single processor (CPU1) environment in accordance with an embodiment of the present disclosure. In this embodiment, an SMP Linux kernel 1000 functions to control hardware and lock guest virtual machines 1002 (supporting a “guest” instance of Linux and running certified and/or untrusted applications) and host virtual machines 1004 (running trusted application core services) to one or more separate CPU threads based on performance and/or security isolation requirements.

In Linux, a “process” generally refers to a task that is tracked by a kernel 1000 for execution. Processes in an operating system such as Linux may be isolated from other processes, as well as the kernel 1000. For example, a process typically cannot access kernel memory. As is known, Linux processes may also utilize multiple execution threads, with each thread sharing the resources of the initiating process but having a separate instruction pointer.

In one embodiment, the SMP Linux kernel 1000 can perform load balancing for processes in both virtual machines across multiple CPU threads or cores when maximum performance is desired. Further, a host virtual machine 1004 with control of a guest virtual machine 1002 can terminate and restart a process in the guest virtual machine 1002 (or the entire container) if it misbehaves or is compromised. Hard limits can be placed on CPU utilization by a guest virtual machine in order to prevent disruption of core underlying device functionality and to facilitate termination of runaway processes. In operation, separate threads may have segregated and/or restricted access to an I/D cache 1006 and L2 cache 1008.

FIG. 11 illustrates integration of trusted and untrusted software in a multi-processor system in accordance with an embodiment of the present disclosure. The illustrated system may be implemented in a device, module, board, etc. One or more components of the system may also be implemented on an integrated circuit chip or on multiple integrated circuit chips. The particular embodiment of FIG. 11 shows two processing modules identified as CPU1 and CPU2, respectively. Although two processing modules are shown, other embodiments may have more than two processing modules or processors, and it is noted that CPU1 and CPU2 may be comprised of various processing devices, circuitry, etc. In one embodiment, CPU1 and CPU2 may be comprised of different processing cores of a single CPU, or some other processing circuitry.

Referring more particularly to the figure, the SMP Linux kernel 1100 (or two such kernels, one executing on each CPU) functions to control hardware and lock a guest virtual machine(s) 1102 instance of Linux (running certified and/or untrusted applications) and a host virtual machine(s) 1104 (running trusted application core services) to one or more separate threads 1-4 based on performance and/or security isolation requirements. For example, an untrusted application might be executed in a virtual machine container that spans both CPU1 and CPU2. As described more fully below, various portions of I/D caches 1106 and 1108 and L2 cache 1110 may be restricted to a particular thread or CPU, or shared with appropriate safeguards.

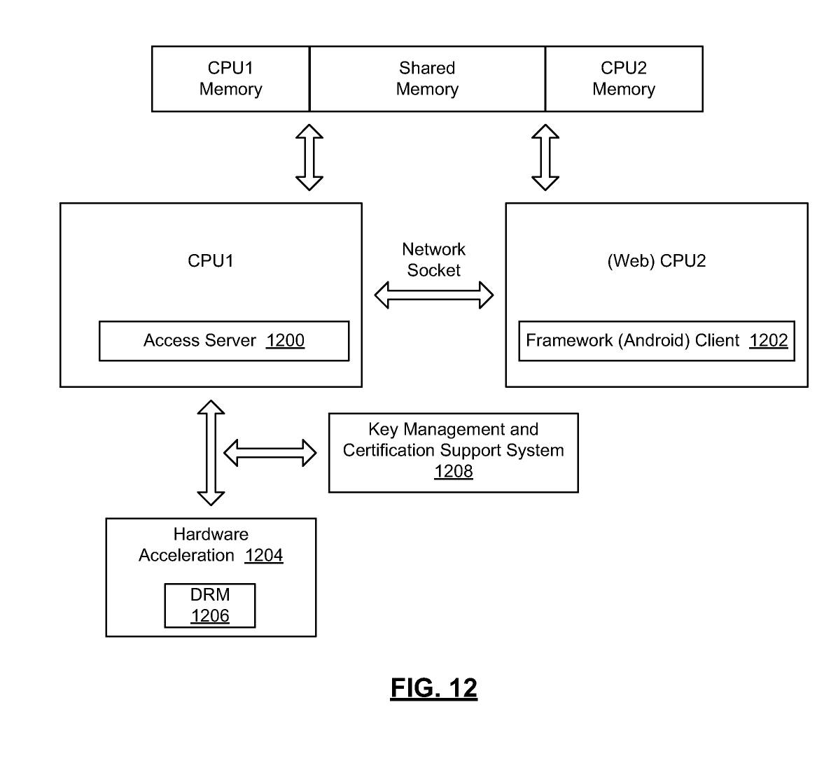

FIG. 12 is a block diagram of another multi-processor system supporting hardware segregation of operating system environments in accordance with various embodiments of the present disclosure. For example, a first processor(s) CPU1 may be dedicated to conventional STB functionality and support a secure access server 1200, while a second processor(s) (web) CPU2 may be dedicated to execution of non-secure functionality and untrusted applications (e.g., an Android framework client 1202 or web browser). A trusted execution environment supported by CPU1 can limit access to certain core STB functionality, including hardware acceleration blocks 1204, DRM capabilities 1206, and the like. Access to and enablement of such components can be controlled by a key management and certification support system 1208, such as described more fully above.

In one embodiment, CPU1 and CPU2 are both segregated into separate and distinct zones when in a “sandboxing” mode. In another embodiment, the trusted CPU1 is set up having its own segregated regions of memory and also given access rights over some or all address ranges of memory mapped portions of CPU2. Generally, when operating in separate or segregated zones, environments or domains, the two CPUs operate on different applications, so that CPU1 executes one set of instructions, while CPU2 executes a different set of instructions. Segregation or separation of this nature is typically referred to as sandboxing or sandbox mode. The purpose of most sandboxing is to prevent one zone from accessing functionality in the other zone or to have controlled access of one zone into another. In some instances, both zones may be limited from having access to the other zone or only have controlled access between zones. In some applications, one zone may be regarded as a secure, privileged or trusted zone and the other as a restricted, non-secure or non-trusted zone, in which access by the applications operating on the non-secure zone are prevented or controlled from accessing certain applications running in the secure zone.

As noted above, a number of devices utilize multiple processors or processing cores to run separate programs, applications, etc. In a situation where one zone is not to have access to a second zone, one way to ensure this separation is by checking the accesses to the system memory. That is, by ensuring accesses that are allocated to CPU1 are not accessed by CPU2, unless the location of the access is a shared location, applications running on CPU2 may be prevented from breaching the functional separation. One way to achieve this protection is to provide an access check and access control to ensure that the correct processing module is accessing a permitted location for that processing module. In the illustrated embodiment, CPU1 and CPU2 may communicate directly through a network socket, IPC calls, etc.

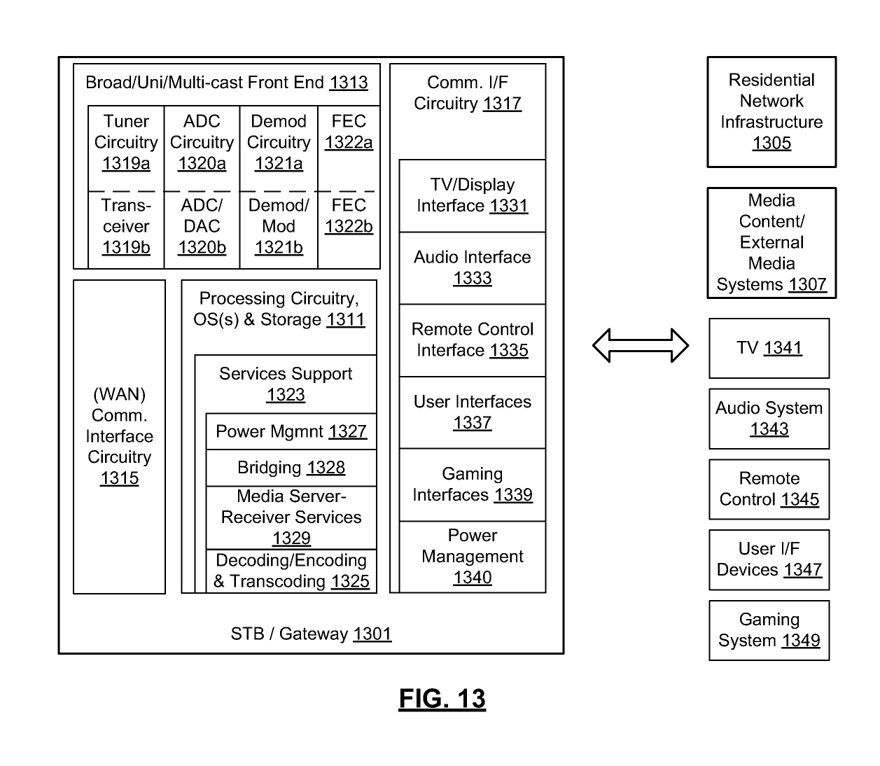

FIG. 13 is a schematic block diagram of a set top box (STB)/gateway (GW) 1301 in accordance with an embodiment of the present disclosure. The STB/gateway 1301 provides a number of functions, including conversion of signals from external sources into content that can be consumed by network devices. The STB/gateway 1301 may further operate as a gateway that supports unidirectional or bidirectional communications and bridging between network devices.

The STB/gateway 1301 of the illustrated embodiment interacts with a residential network infrastructure 1305 and external media systems 1307 via one or more wired and wireless networks/links. The wired and wireless networks/links may utilize one or more of various transmission media—such as coaxial cable, shielded twisted pair cable, fiber-optic cable, power line wires, and wireless media (radio frequencies, microwave, satellite, infrared, etc.)—and operate in accordance with a variety of communication and networking protocols (TCP/IP, UPnP, IPv6, etc.). In addition, the wired and wireless networks/links may comprise a multi-hop network utilizing a spanning tree protocol, direct wireless connections, peer-to-peer links, etc.

The external media systems 1307 may comprise, for example, one or more of cable, satellite and/or terrestrial televisions systems. Various headend equipment and services can be utilized by these systems, such as a cable headend that receives television signals for further processing and distribution, and may offer various other services such as internet connectivity and VoIP services.

The STB/gateway 1301 of the illustrated embodiment includes a broadcast/unicast/multicast front end 1313 that operates to receive uncompressed or compressed digital video, digital audio and other data signals, from either the external media systems 1307 or residential network infrastructure 1305, for further processing and distribution. The front end 1313 comprises tuner circuitry 1319a operable to isolate particular channels. Signals from the tuner circuitry 1319a are then provided to analog-to-digital (ADC) circuitry 1320a and demodulation circuitry 1321a for conversion into binary format/stream. Once in binary format, forward error correction (FEC) circuitry 1322a checks the integrity of the received binary stream. Audio, video, and data extracted from the binary stream may then be decoded (e.g., by decoding 1325) into formats suitable for consumption by downstream devices. It is noted that demodulation circuitry 1321a may support one or more modulation techniques, such as Quadrature Phase Shift Keying (QPSK), Quadrature Amplitude Modulation (QAM), Coded Orthogonal Frequency-Division Multiplexing (COFDM), etc.

The front end 1313 may be integrated into one or more semiconductor devices that may further support, for example, interactive digital television, networked DVR functionality, IP video over DOCSIS applications, and 3D graphics support. In addition, multiple tuner circuitry 1319a (including in-band and out of band tuners), ADC circuitry 1320a and demodulation circuitry 1321a may be provided for different modulation schemes and television standards (such as PAL, NTSC, ATSC, SECAM, DVB-C, DVB-T(2), DVB-H, ISDB, T-DMB, Open Cable).

In one alternative embodiment of the disclosure, functionality of the STB/gateway 1301 is performed by a smartphone or mobile computing device. In this embodiment, the “front end” 1313 comprises one or more wireless interfaces (including PHY and baseband functions), such as a cellular (3G, 4G, IMT-Advanced, etc.) or wide area network (HetNet, Wi-Fi, WiMax, etc.) interface. The interface may support one or more modulation and multiplexing techniques, such as OFDM, OFDMA, SC-FDMA, QPSK, QAM, 64QAM, CSMA, MIMO, etc. In the illustrated embodiment, the wireless interface comprises a transceiver 1319b, analog-to digital (ADC) and digital-to-analog (DAC) circuitry 1320b, demodulation and modulation circuitry 1321b and FEC (such as turbo codes or LDPC codes) circuitry 1322b. Encoding, decoding and transcoding 1325 functions may be provided by processing circuitry and storage 1311.

The STB/gateway 1301 also includes (wide area network) interface circuitry 1315 for communicating with residential network infrastructure 1305 and/or external media system 1307. Through the communication interface circuitry 1315, the STB/gateway 1301 may communicate directly with upstream resources, or offer (bidirectional) bridged communications between such resources and devices (e.g., devices 1341-1349) coupled to the STB/gateway 1301.

In the embodiment of FIG. 13, STB/gateway 1301 interacts with a variety of devices 1341-1349 via communication interface circuitry 1317. For example, a television or display interface module 1331 communicates with a (digital) television 1341 or other media display device to relay television programming and enable available interactive media services. In certain embodiments, the television or display interface module 1331 might include a remote user interface (RUI) server. Similarly, an audio interface 1333 provides audio programming or audio library access to an audio system 1343.

The communication interface circuitry 1317 further comprises a remote control interface 1335 for receiving control signals from a remote control 1345. In addition to traditional remote control operations, the remote control 1345 may further offer voice and/or gesture control signals that are relayed or mapped to relevant consumer devices. User interfaces 1337 are also provided for communications with one or more user interface devices 1347. Gaming interfaces 1339 function to provide interactive communications with a gaming system 1349. Such communications may involve, for example, online, multiplayer gaming between members of a social network and/or external players in a gaming platform. Power management interface 1340 functionality is provided to enable power saving operations between devices 1341-1349.

The STB/gateway 1301 of the illustrated embodiment includes processing circuitry, operating system(s) and storage 1311 (components of which may be comprised of hardware, software, or combinations thereof), services support 1323, and decoding/encoding/transcoding functionality 1325 to support network interactions such as those described above. Services support 1323 in this embodiment includes various functions such as power management 1327, bridging 1328, and media server-receiver services 1329. Other traditional features of a STB/gateway may also be included. For example, the processing circuitry 1311 may include a system-on-a-chip or like device(s) that provide components such as a core processor, audio/video decoder, media processor/DSP, graphics core, encryption/decryption core, adaptive transcoding, etc.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A method for establishing a secure or certified pathway in a media processing device having a plurality of selectable components, the method comprising:
determining a desired level of security for the pathway;
identifying a plurality of the selectable components associated with the pathway; and
selecting a set of the selectable components for use in media-related operations involving the pathway, wherein the set of components, in operation, conform to the desired level of security.

2. The method of claim 1, further comprising:
performing media processing operations over the pathway utilizing the set of selectable components.

3. The method of claim 1, the desired level of security corresponding to requirements of an established certification or testing procedure.

4. The method of claim 1, the desired level of security corresponding to requirements of a conditional access or digital rights management system utilized by a service operator.

5. The method of claim 1, the desired level of security corresponding to a certification requirement for processing and delivery operations involving a particular content item or class of content items.

6. The method of claim 1, the step of determining a desired level of security performed, at least in part, by a service operator, further comprising:
prior to selecting a set of the selectable components, providing an indication of available selectable components to the service operator.

7. The method of claim 1, wherein the plurality of selectable components comprises a plurality of hardware acceleration functions.

8. The method of claim 7, the hardware acceleration functions selected from the group consisting of: video encoding, video decoding, rendering of graphics, digital rights management, encryption, and decryption.

9. The method of claim 2, further comprising:
ascertaining an attempt to breach the security associated with the pathway; and
in response, restricting the performance of a media processing operation associated with the pathway.

10. The method of claim 2, further comprising:
in response to the unavailability or potential unavailability of the set of selectable components, selecting at least one alternate set of components; and
dynamically reestablishing the pathway utilizing the alternate set of components.

11. A method for establishing a certified pathway in a media processing device such as a set top box having a plurality of selectable components relating to operational nodes of the pathway, the method comprising:
determining certification requirements associated with the operational nodes of the pathway;
identifying first and second sets of selectable components for use by the operational nodes of the pathway;
selecting one of the first and second sets of selectable components for use in media-related operations involving the pathway, wherein the selected set of components, in operation, conform to the certification requirements; and
performing media processing or media delivery operations over the pathway utilizing the selected set of selectable components.

12. The method of claim 11, selecting one of the first and second sets of selectable components comprising selecting the set providing the lowest comparative expected power consumption.

13. The method of claim 11, selecting one of the first and second sets of selectable components comprising selecting the set providing the highest comparative performance level.

14. The method of claim 11, further comprising:
identifying a usage conflict or potential usage conflict involving at least one component of the selected set of selectable components; and
in response to the usage conflict or potential usage conflict, dynamically reestablishing the pathway utilizing at least one component of the other set of selectable components.

15. The method of claim 11, the certification requirements provided by a service operator.

16. A media processing device, comprising:
processing circuitry;
an operating system executed by the processing circuitry, the operating system configured to establish at least one privileged operating system environment and at least one restricted operating system environment;
a first set of selectable components controlled or executed by the at least one privileged operating system environment;
a second set of selectable components controlled or executed by the at least one restricted operating system environment; and
a key management and certification support system operable to establish a certified pathway utilizing at least the first set of selectable components.

17. The media processing device of claim 16, further comprising:
a security module operable to detect attempts from the restricted operating system environment to exploit the certified pathway or nodes thereof in an unauthorized manner.

18. The media processing device of claim 17, the key management and certification support system further operable to restrict access to the certified pathway in response to detection of an attempt to exploit the media pathway or nodes thereof in an unauthorized manner.

19. The media processing device of claim 16, wherein the second set of components comprises an untrusted software framework.

20. The media processing device of claim 16, the certified pathway compliant with a certification or conditional access system utilized by a service operator affiliated with the media processing device.
